(19) United States
(12) Patent Application Publication
(10) Pub. No.: US 2013/0327944 A1
(43) Pub. Date: Dec. 12, 2013

(54) HEATED RADIATION SENSOR

(71) Applicants: Henrik Ernst, Katzenelnbogen (DE); Arthur Barlow, Alton (GB); Fred Plotz, Taunusstein (DE)

(72) Inventors: Henrik Ernst, Katzenelnbogen (DE); Arthur Barlow, Alton (GB); Fred Plotz, Taunusstein (DE)

(73) Assignee: Excelitas Technologies Singapore PTE, Ltd., Singapore (SG)

(21) Appl. No.: 13/979,512

(22) PCT Filed: Jan. 20, 2012
(86) PCT No.: PCT/EP2012/050886

§ 371 Date: Aug. 22, 2013

(30) Foreign Application Priority Data
Jan. 21, 2011 (DE) 10 2011 009 128.9

(51) Int. Cl. G01J 5/06

(52) U.S. Cl. CPC G01J 5/061
USPC 250/352; 219/209

(57) ABSTRACT

A heater (15) for a sensor (10) comprises a substrate (20), an electrically conductive heating structure (21) on the substrate (20), and one or more connecting portions (28) for electrically connecting the heating structure (21) to one or more outside terminals (14) of the sensor (10). The substrate (20) is rigid and can comprise ceramics, preferably alumina ceramics.

The invention relates to a heater for a sensor, to a heated sensor and to a radiation sensing method according to the preamble of the independent claims.

Radiation sensors are sensors that convert radiation into an electrical signal. The conversion is in many cases not direct, but indirect in that incident radiation is converted by absorption into a rising temperature, and this temperature—or the resulting temperature change—leads to an electrical signal. Naturally, then, the signal is relatively weak because also the temperature change is relatively weak because the incident radiation has relatively low power. The incident radiation (radiation to be detected) may be predominantly infrared radiation of a wavelength larger than 800 nm.

For such sensors, significant efforts were spent so far for minimizing the effects of thermal noise superimposed on the intermediate thermal signal generated by the incident radiation. A first step of minimizing thermal noise is separating the radiation sensitive portions from the environment as far as possible for avoiding the intermediate thermal signal being short-circuited to thermal ground. Accordingly, sensitive portions of a radiation sensor are usually held on a thin membrane with almost no thermal mass that itself is supported by a frame-like substrate. The substrate has a relatively high thermal mass and may be considered to be thermal ground. Sensitive portions may then be situated on the membrane distant from the substrate.

Thermopiles have cold and hot contacts, and the incident radiation is detected by a temperature difference generated between the hot and the cold contacts by the incident radiation. The incident radiation is guided towards the hot contacts so that they are heated by it above ambient temperature, whereas the,cold contacts are kept at ambient temperature and do not receive the incident radiation so that the temperature difference necessary for detection can develop. In thermopile sensors, the cold contacts are often thermally connected to the substrate as thermal ground for keeping their temperature at ambient temperature. The hot contacts, however, are usually held by the membrane only distant from the substrate/frame. Since the membrane is thin, its mass is almost zero and its thermal capacity may be neglected. Then, except the ambient gas/air, the sensitive portions are disconnected from immediate contact to the environment with high heat capacity. This gives a first success in thermally stabilizing radiation sensors, particularly in situations where the sensor is in thermal equilibrium (constant, equal ambient temperature).

But thermal equilibrium is not always given because the ambient temperature of the sensor may change. In use, the ambient temperature of radiation sensors often changes rapidly. For example, in air conditioning applications, the air flow passing by a sensor may more or less immediately change its temperature from say 17° C. to 27° C., for example upon changed command values. When the ambient temperature changes, the internal temperature of the sensor element itself will also change until thermal equilibrium has been reached again. A changing ambient temperature will cause a temperature change going through the sensor from outside to inside. Then, heat conduction by circulating ambient air/gas and also through the membrane still constitutes recognizable sources of thermal noise, particularly when in thermopile sensors the temperature change reaches the hot and cold contacts at different points of time so that a temperature difference is generated that is not caused by the radiation to be detected, but by the time differences of a temperature change reaching hot and cold contacts. Until the thermal equilibrium is reached, measurement results may again be uncertain to some extent.

For minimizing this effect, placing also the cold contacts of thermopiles on the membrane distant from the support/substrate serves to equalize thermal coupling of hot and cold contacts to some extent to the ambience so that time differences of changes of ambient temperature changes reaching the hot and cold contacts become smaller.

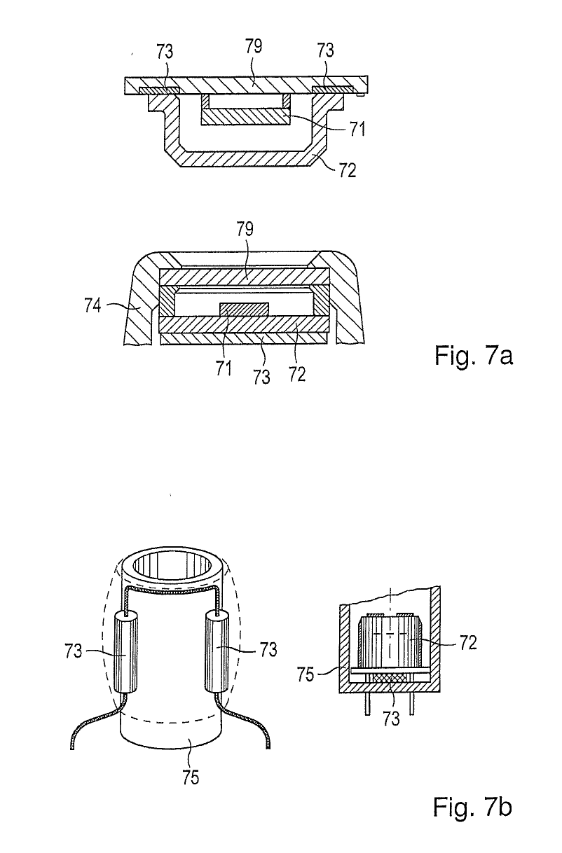

For further minimizing the effect of changing ambient temperature it has shown that actively heating (pre-heating) the sensor in a certain manner reduces the effects of changing ambient temperature on the sensor output signal. FIGS. 7a and 7b show quotations from prior art of sensor heating.

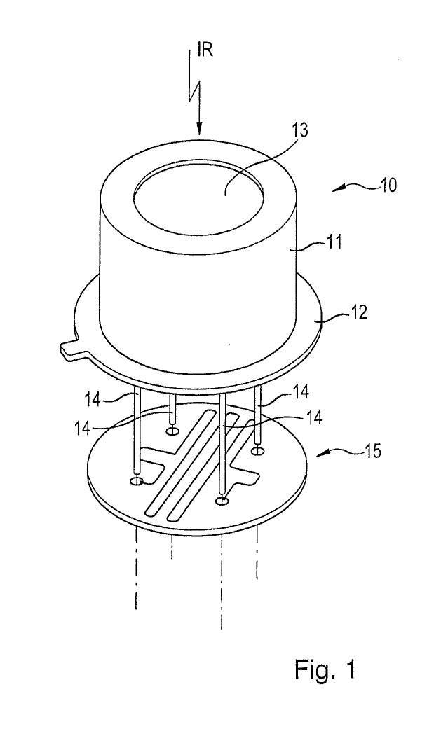

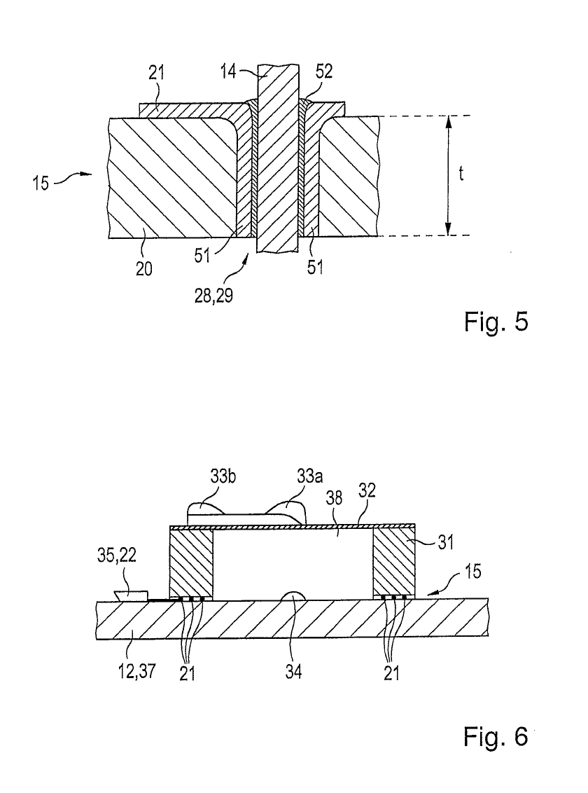

FIG. 7a shows Figures from U.S. Pat. No. 6,626,835 B1. FIG. 1 thereof shows a sensor element 71 accommodated in a casing 72 and immediately attached to a radiation-permeable window 79. At the connecting portion between window 79 and casing 72 a heating element 73 is provided. FIG. 5 of the same publication shows a sensor element 20 provided on the one surface of a casing bottom 72, wherein on the other surface thereof a heating element 73 is provided.

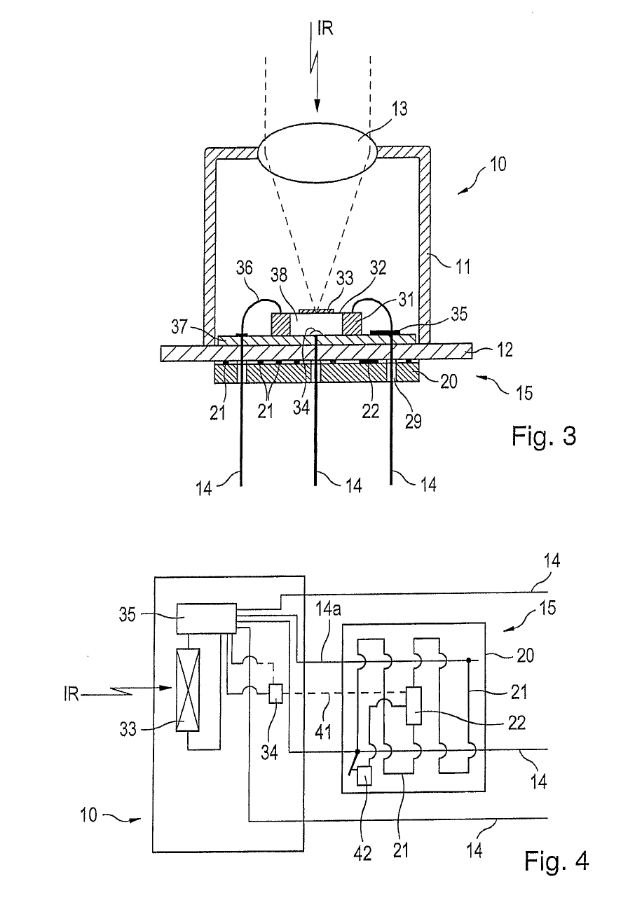

FIG. 7b shows Figures from PCT/US 2009/061842. FIG. 3 thereof shows heating resistors 73 attached to a thermal shield 75, wherein the thermal shield accommodates a sensor. FIG. 7 of the same publication shows a radiation sensor accommodated in a thermal shield 75, wherein a heating element 73 is thermally coupled with the sensor 72.

The disadvantage of known sensor heating constructions are difficulties in the mechanical and/or electrical and/or thermal coupling of the heater with the remaining structures of the sensor. Besides, known ways of using heated sensors have a relatively high consumption of energy, this being particularly disadvantageous in devices with battery power supply.

Preferably, the invention provides a heater which can mechanically, electrically and thermally easily be connected to the sensor to be heated. Further, preferably the invention provides a sensor having an easily attachable heater, and optionally to provide a sensing method with a heated sensor exhibiting reduced power consumption.

Preferably, these aims are accomplished by the features of the independent claims. Dependent claims are directed on preferred embodiments of the inventions.

In a first aspect, the invention provides a heater comprising a resistive electric heating structure held in shape by some kind of carrier or substrate, the heater having a connecting portion for electrically connecting the heating structure to an outside terminal of the sensor. In such an arrangement, a heater can easily be coupled with the sensor to be heated, both electrically, mechanically and thermally.

The heater may comprise a rigid substrate that may be plate-shaped and on which the heating structure is formed. The heater may be an independent device that is separately attachable to the sensor either before the final assembly of the sensor or after its otherwise final assembly. The heater substrate may show on at least one of its surfaces a form fit to a surface of the sensor to be equipped with the heater.

The heater substrate may comprise through-holes or recesses allowing external sensor terminals to pass through or pass by the heater so that an immediate electrical contact to at least one of the terminals can be established.

The outer shape (plan view contour) of the heater substrate may be the same as that of a plan view contour of the sensor to be equipped with the heater.

The heating structure may be a printed conductive pattern or line which may constitute an elongated conductor of an overall desired resistance. It may be formed from a conductive paste. The conductor may be meandering on the substrate surface according to a desired pattern for covering, and thus heating, the desired surface portions. One end or both ends of the meandering conductor may be directly connected to outside terminals of the sensor.

The heater may comprise circuitry, particularly control circuitry. It may comprise a temperature sensor or a terminal for receiving a temperature signal from an otherwise provided temperature sensor, particularly from a temperature sensor inside the radiation sensor. The control may be a forward control or a feedback control.

The material of the conductive heating structure may be of practically constant resistance over temperature (change of less than 5% in a nominal operating temperature range) or may rise with rising temperature (PCT—positive temperature coefficient).

The sensor may be formed as a housing with solderable wires extending out of one of the housing surfaces, or it may be a surface mounted device (SMD) with soldering bumps or contact pads on one or more surfaces thereof.

In a further aspect, the invention provides a method of sensing radiation from an object, comprising the step of pre-heating a sensor, wherein the pre-heating target temperature is a temperature or temperature range below an expected temperature of the object and/or a temperature or a defined temperature range that is a defined temperature above the ambient temperature of the sensor.

In the following, embodiments of the invention will be described with reference to the attached drawings in which

FIG. 1 is a perspective view of a first embodiment of the invention,

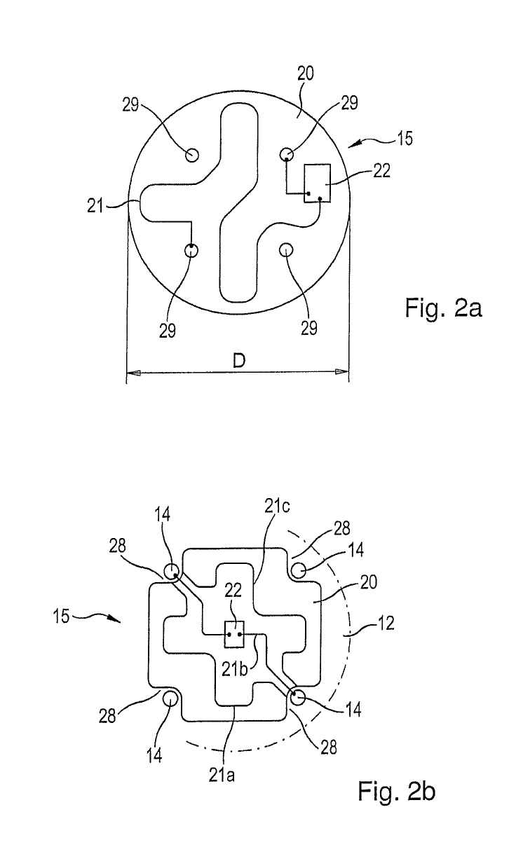

FIGS. 2a and 2b are schematic views of embodiments of the heater,

FIG. 3 is a schematic sectional view of a sensor,

FIG. 4 is a schematic circuit diagram,

FIG. 5 is a detail for connecting the heater,

FIG. 6 shows an alternative way of providing the heater, and

FIG. 7 shows prior art.

FIG. 1 shows a sensor that may be used for radiation detection, preferably in the infrared wavelength range. The detected incident radiation may be predominantly infrared radiation of a wavelength larger than 800 nm. The sensitivity maximum may be between 800 nm and 15 μm wavelength.

FIG. 1 shows a sensor 10 and a heater 15 in a schematic perspective view. The sensor 10 is in the shown embodiment an infrared sensor receiving infrared (IR) radiation for detecting it. It may be used for temperature measurement or for presence detection. The sensor 10 in the shown construction comprises a housing consisting of a base member 12 and a cap 11 that has a radiation entrance window 13 permitting entrance of IR radiation from outside into the inside of the sensor housing. The window 13 may have focussing properties and may be or comprise a lens, a Fresnel lens, a phase plate, a converging mirror or the like. Its material may be some kind of glass or resin or other material permeable for infrared radiation, such as silicon.

The sensor may have several contact wires or terminals 14 for connecting the sensor with external circuitry for supplying energy to the sensor and for supplying signals to the sensor and away therefrom. Signal input and output may be analogue or digital, and if digital parallel or serial. The inside construction of the sensor in certain embodiments is shown FIGS. 3 and 6 and will be described later.

15 is a heater for the sensor. In the shown embodiment, it is separately manufacturable from the sensor and can, as a unit, be attached thereto. In the shown embodiment, it is attachable to the underside of sensor 10 and may mechanically be fixed at sensor 10 by glue or resin, which is preferably of relative good heat conductivity for establishing not only the mechanical contact but also good thermal contact. Generally, the heater 15 shows for at least a portion of its surface a form fit to a surface or a surface portion of the sensor 10 so that an intimate contact for establishing good thermal connection amongst heater 15 and sensor 10 is given.

FIG. 2 shows a more detailed schematic view of heater 15. It comprises a substrate 20 on which an electrically conductive heating structure 21 is formed. It may have the shape of an elongated conductor with a certain (specific) resistance for converting electrical power/current into heat. The conductor 21 may meander across the surface of substrate 15 in a desired way for covering the surface portions desired for heating.

The heater 15 may, but needs not, comprise a circuit 22 thereon, suitable for controlling current flow through the heating structure 21. FIG. 2 shows an embodiment where one single heating structure 21 is provided between connecting end points. The heating structure 21 receives electrical power such that current flows through it. The consumed electrical power is converted into heating power Hp according to Hp=V×I, wherein V is the voltage drop along the heating structure and I is the flowing current. Accordingly, when the heater 15 is in contact with sensor 10, the sensor is heated by a part of the heating power generated in heater 15.

The outer contour of the heater substrate 20 may be such that it matches, or is smaller than, the outer contour of the mounting surface of the sensor 10. In the shown examples, the sensor base plate 12 may be of round/circular shape, and the heater substrate 20 may have a matching shape, and particularly a diameter D same as, or smaller than, that of sensor base plate 12.

Power supply to the heating structure 21 may be made such that at least one terminal of the heating structure 21 is directly connected to an external connection terminal 14 of sensor 10. FIG. 2a shows an embodiment where the heater base plate 20 has through-holes 29 that allow the sensor external connecting wires 14 to pass through. Accordingly, the arrangement pattern of the holes 29 on the heater substrate 20 corresponds to the arrangement pattern of the connecting wires 14 of the sensor. It is pointed out that the heater substrate 20 needs not necessarily extend across/towards all connecting wires 14. Then, naturally, holes 29 are provided only for those positions of terminal wires 14 covered by the substrate 20. At least one end portion of the heating structure 21 may then be connected to an external terminal 14 of the sensor 10.

FIG. 2b shows an alternate design. Substrate 20 is formed such that it gets close to some or all of the external terminal wires 14 of sensor 10. “Close” in this context may mean a distance smaller than 1 mm, preferably smaller than 0.5 mm, or less than a cross-sectional dimension (e.g. diameter) of wire 14, or less than 50% thereof. Then, also the heating structure 21 can contact at least one external terminal wire 14 of sensor 10. FIG. 2b further shows an embodiment where not one single heating structure 21 is provided. Rather, plural wirings 21a, 21b and 21c are connected in parallel and share at least one common connecting point. They also may share connecting the points at both ends. FIG. 2b further shows an embodiment where only one of the wirings (21b) is connected to a control circuit 22 for controlling current flow therein. But likewise, plural of the wirings 21a, 21b or 21c or all of them or none of them may be connected with a control circuit 22.

The dashed line in FIG. 2b indicates the outer contour of the surface (base plate 12 in the shown example) of the sensor 10 to which the heater 15 is to be mounted. The outer contour of heater substrate 20 remains within the outer contour of the sensor 10 to which the heater is to be mounted. Instead of through-holes 29, the embodiment of FIG. 2b shows an outer contour of the heater substrate 20 that has recesses or notches 28 formed in accordance with the position of the external terminal wires 14 of sensor 10. An embodiment combining through-holes 29 of FIG. 2a for some of the external connecting wires 14 and recesses 28 of FIG. 2b for some other of the external connecting wires 14 is also possible.

The heating structure 21 may be a printed conductive line, e.g. formed from a conductive paste, which may constitute an elongated conductor of an overall desired resistance. It may be formed by known processes. The heating structure may comprise one or more calibration portions for adjusting its characteristics, particularly its resistance, after its first manufacturing. Adjustment may, for example, be made by laser trimming by burning away conductive portions for increasing resistance of the heating structure.

FIG. 3 shows a sectional view of a sensor 10 equipped with heater 15. Inside the sensor housing is a sensing portion 31-33 that converts incident infrared radiation into an electrical signal. The sensing portion may comprise a substrate 31. It may be of frame-like shape, i.e. surrounding a recess or a through-hole 38. The substrate 31 may comprise or be made of silicon or similar materials. A membrane 32 may span across the recess 38 or opening in the substrate 31 and may carry the actual sensor elements 33. It is pointed out that the Figures are not to scale. The outer diameter of the sensor cap 11 may be between 3 mm and 8 mm. The width-wise dimension of the sensing portion 31-33 in FIG. 3 may be between 1 mm and 3 mm.

Electrical signals from the sensor elements 33 are led via bond contacts 36 to external terminals 14 of the sensor and/or to internal circuitry 35 of the sensor, which in turn may be connected to external terminal wires. The sensor 10 may further comprise a temperature sensor 34 for sensing the internal temperature of the sensor and providing a related signal either to an external terminal 14 and/or to internal circuitry 35 for further use there.

In FIG. 3, a heater 15 is attached to the outer surface of the underside of sensor 10, i.e. to the lower surface of base plate 12 of the sensor housing. The heating structure 21 is provided on the surface facing the sensor surface so that the heating structure 21 is mechanically protected by the heater substrate 20, which also provides some kind of thermal isolation so that the heating power will more efficiently diffuse into the sensor 10 rather than into the ambience of sensor 10. Alternatively, the heater structure 21 may be placed on the lower surface of the heater substrate 20 so that the heater resistance may be electrically isolated from the sensor housing. Again alternatively, the heater structure 21 may be placed on the lower surface of the housing base plate 12.

Optionally, in addition to the base-plate 12, the sensor may comprise an internal substrate 37 such as a circuit board carrying several or all of the installations (31-36) inside the sensor. For improving heat flow from the heater 15 towards the inside of the sensor 10 a construction may however be preferred that does not have an additional internal substrate 37 in addition to the sensor base plate 12. Then, particularly the sensing portion 31-33 is directly mounted on the sensor base-plate 12. Internal connections of the components in the sensor housing may be made by bond wiring and/or by printed wiring on the housing base plate 12 or the internal substrate 37.

But instead of being attached to an outside surface of sensor 10, the heater 15 may also be attached to an inside surface of the sensor 10, for example to the upper surface of base plate 12 or to the lower surface or upper surface of an internal substrate 37. It is pointed out that in these cases the heater 15 needs not necessarily to have an own substrate 20. Rather, the sensor base plate 12 or the internal substrate 37 of sensor 10 may serve as heater substrate 20. Such embodiments are particularly suited for SMD sensors where the lower surface is designed to immediately contact external structures such as a printed circuit board so that it is not accessible for mounting the heater 15 to the outside surface. But just as in the earlier embodiments, the plate/substrate serving as the heater substrate 20 may have through-holes 29 and/or notches 28 permitting external contacts to pass through or pass by. And as mentioned above, the heating structure 21 may directly be connected to at least one of the external terminals 14 which may be terminal wires as shown in FIG. 3 or which may be connections towards contact areas or contact bumps of an SMD.

FIG. 3 shows a sensor with one sensing element 31 33. But also plural of them may be provided, preferably in a regular array, for obtaining spatial resolution by sensing focussed incident radiation. The housing may be a TO housing; such as TO5 or TO22.

FIG. 4 shows a schematic electrical circuit of the overall sensor 10 equipped with heater 15. 33 indicates the actual sensor element converting radiation into an electrical signal. 35 indicates internal circuitry of the sensor 10 that may be provided in the sensor. It may have functions of one or more of signal shaping, signal conversion (analog-digital), characteristics adaptation, impedance conversion, multiplexing amongst plural sensor elements, providing internal settings, communication control, data storage, heating control, and the like. The internal circuitry may be connected to one or more of the respective external terminals 14. If provided, the internal circuitry 35 may also receive a signal from the internal temperature 34.

The external terminals 14 are therefore exchanging energy and signals with the sensor inside. At least one of them may also directly be connected to the sensor element 33. Box 20 in FIG. 4 stands for the substrate of heater 15. It carries the heating structure 21, shown as a single elongated conductor. In the shown example, said heating structure 21 is connected at its both ends to external terminals 14 of the sensor.

Further provided is a control circuit 22 that may control current flow through the heating structure 21. Control may be made for maintaining a target temperature or a target temperature range. Control may be made in accordance with a temperature sensor 42 that may also be provided on the heater substrate 20. The sensor may be connected with one terminal thereof with an external terminal 14 of the sensor. Another terminal of sensor 42 may be connected with the control circuit 22 of heater 15. This renders a feedback structure in that temperature information of the temperature generated by the heating structure 21 is fed back via sensor 42 to the control circuit 22. But instead of a feedback structure, control may also be made without feedback.

Instead of having an own sensor 42, the heater 15 may also receive a signal from a temperature sensor 34 inside sensor 10, as indicated by dashed line 41. It is pointed out in this context that one or more of the external terminals 14 of the sensor 10 may be provided for the sole purpose of contacting an outside heater 15. This option is indicated by terminal 14a in FIG. 4 not reaching beyond heater 15. Control of heating power/current flow through the heating structure may also be made by the internal circuitry 35 of sensor 10. Then, heater 15 may in fact only carry the heating structure 21, connected to external terminals (one of them, for example, being ground or the supply voltage). The internal circuitry 35 of the sensor may then accomplish current control.

The maximum operating voltage of the heater may be below 20 V and may be a usual battery voltage such as 9V or a multiple of 1.5 V. A controller may control the effective voltage applied across the terminals of the heater to be same as, or lower than, the maximum operating voltage. The control may comprise or be a pulse width modulation.

FIG. 5 shows an embodiment of how an external terminal 14 may contact the heating structure 21 of heater 15. The detail shows a vertical sectional cut through a through-hole section or a recess section of the heater substrate 20, indicated by 28, 29 in FIG. 5. The vertical walls of through-hole 29 or recess 28 may be covered by a metallization 51. Terminal 14 may be soldered to metallization 51 or may contact it by other appropriate means, for example mechanical pressure or the like. 52 symbolizes the solder connection between the metallization 51 of hole 29 or recess 28 and external terminal 14. Metallization 51 is in electrical contact with electrical components of the heater 15, particularly the heating structure 21 or other wiring.

The substrate 20 of heater 15 may be a rigid substrate. It may be made of ceramics, particularly alumina ceramics. It may have a thickness t of less than 1 mm, preferably less then 0.5 mm. In an alternative embodiment, the substrate may be or comprise a flexible material, such as a plastic sheet or film or a resin sheet or film, e.g. Mylar, of appropriate shape and stiffness.

FIG. 6 shows still another embodiment of providing heater 15. The substrate 31 of the sensing portion 31-33 serves as substrate 20 of heater 15 and carries for example on its underside the heating structure 21 that is connected to external terminals 14 of the sensor 10 and/or to internal circuitry 35 of the sensor 10 or to dedicated control circuitry 22 of heater 15. The sensing portion 31-33 may be provided immediately on the base-plate 12 of the sensor 10 or on an intermediate substrate 37.

The wiring pattern of the heating structure 21 in the FIG. 6 embodiment may be that of a spiral running around recess 38 encompassed by substrate 31. Such a spiral would have two terminals for power supply. Instead of a spiral, parallel, loops may be provided that are electrically connected in parallel to each other. Instead of being attached to the underside of sensing portion substrate 31, the heating structure 21 may also be attached to another surface thereof, for example the outer or inner sidewalls thereof.

As said above, the sensor element 33 may be a pyro-electric element, a bolometer or a thermopile. It may comprise “hot” contacts 33a held above orifice 38 on membrane 32 and may comprise cold contacts 33b that may be situated above the substrate 31 to be in close thermal contact therewith (as shown in FIG. 6) or may also be held above recess 38.

A sensing method may comprise controlling the temperature at a portion inside sensor 10 by a sensor heater 15 to a certain target temperature or to fall into a target temperature range preferably before the actual measurement values are taken. The target temperature or target temperature range may be chosen to coincide with, or include, an expected temperature of a measurement object emitting infrared radiation. In thermometer applications for humans, for example, the expected temperature may be around 35° C. in the case of ear thermometers. The target temperature may then be 35° C. or a temperature range (+/−0.5° C., +/−1° C.) around it. This would minimize temperature distortions because the changing ambient temperature would not be experienced by the sensor because it (or its relevant portions at least) are already at the temperature of the new environment (the human ear channel, for example).

In another embodiment it may be desirable to keep the temperature at a lower value or value range than the expected temperature, for example by a certain amount (first difference temperature) below it (for example at least a value of 3° C. to 7° C. below the expected temperature). This decreases heating power and decreases the time required for heating up the sensor 10 by heater 15 upon switch-on and increases sensitivity. A further control goal may then be to keep the temperature by a certain amount (second difference temperature, e.g. 3° C. to 7° C.) above the present ambient temperature (i.e. in thermometer applications usually room temperature). For example, a control goal may be to bring the temperature at the relevant sensor portions to a temperature of 7° C. above a present equilibrium temperature. When then the thermometer is inserted into the ear channel, it will take a certain time for the temperature rise to exceed the already established distance. In this time span measurement can be completed so that a changing temperature will not be experienced by the sensing portion although it was not completely heated up to the expected temperature of the measurement object (ear channel in the chosen example).

For minimizing heating effects in the sensor from unwanted external sources, the sensor may on its outside and/or on its inside be provided with thermal insulation means (not shown in any of the Figures). It may be a kind of jacket of thermally insulating material, preferably form-fitting, surrounding or covering significant portions of the sensor surface, for example a cylindrical jacket covering the outer periphery and possibly also parts of the top surface of sensor 10 as shown in FIG. 1. This again improves thermal insulation of the sensor against its ambience and thus increases the time span within which measurement can be made before an external temperature change reaches the inside sensor.

Also part of the invention is a thermometer comprising the described sensor and/or using the mentioned method. It may be an ear thermometer comprising an outer housing, the sensor, control circuitry, preferably user input means such as one or more switches, and a display and/or another appropriate analogue or digital signal output.

In this specification and the appended claims, same reference numerals shall denote same components. Features described herein shall be deemed combinable with each other also if this is not explicitly said, as far as a combination is not excluded by technical reason. Apparatus features shall be considered as disclosure also of features of methods implemented by the mentioned apparatus features, and vice versa.

1. A heater for a sensor, comprising:
a substrate;
an electrically conductive heating structure on the substrate; and
one or more connecting portions for electrically connecting the heating structure to one or more outside terminals of the sensor.

2. The heater of claim 1, adapted to heat the sensor to a predetermined temperature or temperature range, which may be a predetermined amount below an expected temperature of a radiation source and/or a predetermined amount above an expected ambient temperature of the sensor.

3. The heater of claim 1, comprising a control circuit for controlling the temperature of the heater.

4. The heater of claim 3, comprising a circuit terminal adapted to receive a temperature signal from the inside of the sensor, and/or comprising a temperature sensor.

5. The heater of claim 1, wherein the conductive structure is an electrically resistive heater of a resistance that is constant over temperature or that is rising with rising temperature.

6. The heater of claim 1, wherein the conductive structure comprises a printed structure.

7. The sensor of claim 1, wherein the conductive structure comprises a trimmable structure.

8. The heater of claim 1, wherein the substrate comprises one or more holes respectively adapted to accommodate an external terminal of the sensor.

9. The heater of claim 8, wherein the internal wall of one or more of the holes comprises a metallization connected to a circuit element and/or to the conductive structure on the substrate.

10. A heater for a sensor, comprising:
a substrate;
an electrically conductive heating structure on the substrate; and
one or more connecting portions for electrically connecting the heating structure,
wherein the substrate is rigid and comprises ceramics.

11. The heater of claim 10, wherein the substrate has the shape of a flat plate of a thickness less than 1 mm, and is adapted to be glued to a surface of the sensor.

12. The heater of claim 10 wherein the substrate is the substrate of the sensing portion.

13. A radiation sensor comprising:
a sensing portion configured to generate an electrical signal in accordance with incident radiation;
a housing accommodating the sensing portion and having a radiation window permitting radiation to enter the housing and reach the sensing portion; and
an electrical heater configured to heat the sensor,
wherein the heater is attached to, and thermally connected with, a wall portion of the housing and is electrically connected with at least one outside terminal of the sensor.

14. The sensor of claim 26 wherein the heater is attached to the substrate of the sensing portion.

15. The sensor of claim 13, wherein the heater comprises a rigid substrate.

16. The sensor of claim 13, wherein at least one electrical terminal of the heater is directly electrically connected to an external terminal of the sensor.

17. The sensor of claim 13, wherein the heater comprises:
a substrate;
an electrically conductive heating structure on the substrate; and
one or more connecting portions for electrically connecting the heating structure to one or more outside terminals of the sensor.

18. The sensor of claim 13, formed as a surface mounted device, wherein the heater is provided inside the sensor housing between the mounting surface of the sensor and the sensing portion.

19. A radiation sensor comprising;
a sensing portion generating an electrical signal in accordance with incident radiation;
a housing accommodating the sensing portion and having a radiation window permitting radiation to enter the housing and reach the sensing portion; and
an electrical heater for heating the sensor, comprising
a substrate,
an electrically conductive heating structure on the substrate, and
one or more connecting portions for electrically connecting the heating structure to one or more outside terminals of the sensor.

20. The sensor of claim 19 wherein the heater substrate is a base plate of the sensor housing.

21. The sensor of claim 13, formed as a surface mounted device and having the heater inside the housing.

22. A method of sensing radiation from an object, comprising the step of pre-heating a sensor by a heater, wherein the pre-heating target temperature is a temperature or temperature range that is a certain first difference temperature below an expected temperature of the object, and/or a temperature or temperature range that is a certain second difference temperature above ambient temperature before heating.

23. The heater of claim 10, wherein the substrate comprises ceramics.

24. The heater of claim 10, wherein the substrate is non-rigid and comprises a thin film.

25. The heater of claim 10 wherein the substrate is the membrane of the sensing portion.

26. A radiation sensor comprising:
a sensing portion configured to generate an electrical signal in accordance with incident radiation;
a housing accommodating the sensing portion and having a radiation window permitting radiation to enter the housing and reach the sensing portion; and
an electrical heater configured to heat the sensor,
wherein the heater is attached to, and thermally connected with, the sensing portion and is electrically connected with at least one outside terminal of the sensor.

27. The sensor of claim 19 wherein the heater substrate is an intermediate substrate of the sensor.

28. The sensor of claim 19 wherein the heater substrate is the substrate of the sensing portion.
